(19) United States
(12) Patent Application Publication
(10) Pub. No.: US 2008/0126124 A1
(43) Pub. Date: May 29, 2008

(54) Quantitative assessment, evaluation and triage of the health status of an individual

(76) Inventor: Alan M. Schechter, Long Beach, CA (US)

Correspondence Address: STETINA BRUNDA GARRED & BRUCKER, 75 ENTERPRISE, SUITE 250, ALISO VIEJO, CA, 92656, US

(21) Appl. No.: 11/605,990

(22) Filed: Nov. 28, 2006

(51) Int. Cl. G06Q 50/00

(52) U.S. Cl. 705/2

(57) ABSTRACT

A method for the quantitative assessment of an individual's health status comprising selecting at least one measurable parameter of an individual; segmenting each parameter into a plurality of ranges that include a measured result for each selected parameter; assigning a scaled value to each range for each selected parameter to order the ranges according to severity; assigning an importance value for each selected parameter that establishes a proportionate relationship between the selected parameters; calculating a health status index score by multiplying an individual metric based on the scaled value which corresponds to the measured result of an individual by the importance value for each selected parameter and summing each of the products; and determining a critical index that corresponds to a minimum health status index score that causes an individual to be authorized for specialized treatment.

### CROSS-REFERENCE TO RELATED APPLICATIONS

Not Applicable

### STATEMENT RE FEDERALLY SPONSORED RESEARCH DEVELOPMENT

Not Applicable

### BACKGROUND

The traditional approach to healthcare delivery and treatment is often reactive instead of proactive. Reactive healthcare delivery is generally characterized as emergency treatment that is initiated by a catastrophic event. In contrast, a proactive approach to healthcare delivery entails some form of monitoring before the occurrence of a catastrophic event, such as a stroke or a heart attack. Moreover, a proactive approach that includes early and frequent monitoring is imperative for people suffering from current and potential chronic conditions. However, many individuals labeled as high risk patients receive the appropriate and necessary care only subsequent to the occurrence of a catastrophic event. Similarly, an individual may begin to receive high risk treatment as a last resort after repeated, and unsuccessful, attempts to control a chronic condition. These attempts usually focus on less involved methods of treatment or through disease management programs once a diagnosis has been made.

Healthcare delivery and treatment options may have a widely varied focus, as demonstrated in the different approaches to healthcare that are currently in practice today. For example, population management, disease management and case management are terms used to describe the most commonly used approaches to the delivery of healthcare for individuals who currently are or may be considered high risk. Population management involves providing information and other general support to enable individuals to become active participants in their own healthcare. The goal of population management is to enable individuals to live with and manage their conditions before a high risk stage is reached. Population management requires that an individual follow healthy lifestyle guidelines, such as maintaining a proper diet and exercise program, ceasing detrimental behaviors such as tobacco or alcohol abuse and engaging in preventative screening, including blood and cholesterol testing and chest x-rays. With the right support, individuals can prevent complications and slow down bodily deterioration. However, the average individual who is at risk for developing a chronic condition does not usually have the necessary self-control and discipline to incorporate these behaviors into their daily lifestyle. Thus, the success of population management depends on the individual.

Disease management is another form of proactive care management which involves following agreed upon protocols and pathways for managing specific diagnosed chronic conditions. Disease management is often predicated on promoting self-management and physician adherence to evidence-based guidelines. Disease management programs are developed to manage the health of the individual patient in a manner that directly correlates to the best treatment method for that individual. A healthcare provider initially evaluates the exhibited symptoms of the individual and determines a proper diagnosis based on the symptoms. Subsequent to the diagnosis, a relevant course of treatment is developed that is tailored to the needs of the individual and the diagnosed disease condition. However, this approach is not always successful.

Although disease management has a demonstrated potential for improving the quality of healthcare received with respect to an index diagnosed chronic disease, most programs are not designed to coordinate care among multiple providers or to manage simultaneously suffered health conditions unrelated to the index disease. Disease management is viewed as a siloed approach versus a more holistic approach, which means that treatment is difficult to coordinate for an individual suffering from one chronic condition. Treatment becomes even more complex to coordinate, if not almost impossible, when the individual suffers from two or more chronic conditions. For example, heart failure, depression and diabetes are three common chronic conditions that are suffered by older adults. Each of these chronic conditions is almost always accompanied by other conditions that may or may not be related. In fact, research has shown that many people commonly suffer from four or more chronic conditions in addition to an index disease. Often an individual suffering from these types of conditions must utilize the services of various providers including specialists and inpatient, outpatient and emergency facilities. The information pertaining to each provider and patient interaction is not typically shared among the various providers or even with the primary care physician unless requested.

Finally, case management is appropriate for individuals that are medically complex. The case management approach is typically used to formulate a comprehensive and customized approach to coordinate an individual's healthcare needs. As an individual develops multiple chronic conditions or co-morbidities, the necessary care becomes disproportionately more complex and difficult for the individual or the healthcare system to manage. Thus, case management, which often involves a key person such as a nurse, is implemented to actively manage care for such individuals. However, the close monitoring that accompanies the case management approach is often too late to save the individual from an advanced disease state or a catastrophic event.

Individuals of any age can suffer from multiple chronic conditions simultaneously depending on lifestyle, genetic and other environmental factors. However, identifying effective approaches for delivering healthcare in the area of chronic disease is particularly relevant to older adults for whom chronic disease is the norm rather than the exception. Novel methods of providing specialized healthcare services, such as high risk treatment, to individuals in a chronic disease state have achieved varying levels of success because these methods generally do not have a mechanism with which to assess the individual for entry into a program that provides specialized healthcare treatment services. By the time the individual enters such a treatment program, the individual's condition is generally far advanced. Moreover, the identified approaches do not have a quantitative method to evaluate whether an individual patient should remain in or exit a specialized healthcare program. Once the identified chronic disease state has been effectively controlled, the individual may no longer need the closely monitored treatment. However, the individual may still require some form of monitoring, which is usually not received. For example, during the treatment, additional conditions may have developed which will not qualify the individual for specialized healthcare service again until the occurrence of a catastrophic event or until a condition is officially diagnosed and found to be unmanageable. Finally, the identified approaches do not trend an individual's progress while in a specialized healthcare treatment program. By trending an individual's health status over time, a provider can be assured that a particular treatment is effective and that other conditions have not developed.

With further regard to the various approaches to healthcare, many of the common diseases of adult life, including those mentioned above, have a strong genetic component to their occurrence. Generally, an individual that may be genetically predisposed to a chronic condition previously identified in another family member is not pre-screened or monitored prior to the development or onset of symptoms of the potentially inherited disease state. As a result, the individual does not begin any treatment, preventative or otherwise, until the individual develops symptoms of the disease state. The current approaches to healthcare do not adequately address a genetic condition to provide preventative healthcare services to individuals in the blood line to prevent disease proliferation or lessen the devastating health effects in the family members once a genetic source has been identified. Moreover, once a family member of an individual has been diagnosed with a genetic condition, the healthcare approach for the individual should not only focus on the genetically inherited diagnosed disease state, but also the co-morbidities that may be anticipated or unexpected.

Once the individual's health condition becomes so complex that many providers are involved in the delivery of healthcare to the individual, a quantitative method of assessing the individual's current health status is almost necessary for determining the effectiveness of the prescribed treatments. If at least one physician or group involved in the individual's treatment implemented a diagnostic quantitative assessment tool to monitor the status of the individual, the patient's health status could be managed appropriately. Accordingly, healthcare could be administered in a proactive manner as opposed to a reactive.

There is a need for a method to identify and quantify the health status of a potentially at-risk patient prior to entry into a specialized treatment program to prevent the increased cost of health care services associated with high utilization. There is also a need to develop a pre-emptive method of assessing the health status of an individual while the individual is considered healthy and before specialized treatment is required. Furthermore, there is also a need to assess the health status of an individual if a familial history or genetic predisposition is established, even if the individual is currently asymptomatic for the genetic condition. In addition, there is a need to assess the health status of the individual through the individual's progression of age. The method should define a holistic treatment approach to maintaining a general state of well-being throughout the normal aging process instead of addressing issues based on an episodic event or a single disease state. By monitoring any current chronic conditions of an individual, in addition to those conditions that have a high probability of occurring within the bloodline, and any other conditions for which the individual may be asymptomatic, each of the chronic conditions from which an individual may suffer may be proactively identified and controlled. As a result, the high cost and debilitating effect of such conditions may be minimized. The method should assess the patient's condition at various stages during the patient's life to determine if treatment is needed and if so, the method should assess appropriate care and treatment options.

### BRIEF SUMMARY OF THE INVENTION

A method for the quantitative assessment of the health status of an individual is disclosed which comprises selecting at least one measurable parameter of an individual; segmenting each parameter into a plurality of ranges that include a measured result for each selected parameter; assigning a scaled value to each range for each selected parameter to order the ranges according to severity; assigning an importance value for each selected parameter that establishes a proportionate relationship between the selected parameters; calculating a health status index score by multiplying an individual metric based on the scaled value which corresponds to the measured result of an individual by the importance value for each selected parameter to obtain an intermediate product and summing each of the products; and determining a critical index level that corresponds to a minimum health status index score that causes an individual to be authorized for specialized treatment. The method may further comprise the calculation of a danger level corresponding to the minimum health status index score that may provide an indication of at least one developing chronic condition.

The disclosed method utilizes measurable parameters that may include physiological and/or psycho-social parameters. The physiological parameters may include without limitation at least one of body mass index, blood pressure, heart rate, low-density lipoprotein level, temperature, hydration level, respiratory rate, heart rate, body temperature, body weight, food consumption, water consumption, creatinine, sodium, potassium, BUN and HgbA1c. The psycho-social parameters may include without limitation anxiety, fatigue, anger, hopelessness, depression, social support, sense of mastery, uncertainty, changed sleep patterns, stress, weaning self efficacy and activity level. Parameters may be selected in relation to known chronic conditions in addition to other co-morbidities for which the individual may or may not be symptomatic and other known genetic predispositions.

The method may also utilize other disease factors to assess the health status of the individual, in addition to physiological and psycho-social parameters, which may include without limitation, at least one of a co-morbidity, MRSA, VRE, Valley Fever, C-Diff, the number of hospitalizations, insulin dependence, incontinence of bowel or bladder, steroid dependence, oxygen dependence, cirrhosis/hepatitis with abnormal LFTS, level of forced lung expiration, lung vital capacity and age.

Each of the parameters and disease factors may be segmented into a number of ranges, and each range may be assigned a scaled value. For each parameter, the scaled value may be multiplied by an importance value that is assigned to each parameter or, in the case of a disease factor, the scaled value is multiplied by the constant assigned to the disease factor. Each constant and importance value should be proportionate in weight for the selected parameters and disease factors and relative to the perceived health status of the individual.

The method may further comprise the step of comparing the health status index score to the critical index level to monitor the health status of an individual. A trend analysis of the health status index score may be utilized to monitor the health status of the individual over a period of time. For example, the health status index score may be utilized to predict the probability of a catastrophic event; to predict the individual's entry into a high risk specialized treatment program; to determine the individual's status as a high risk patient or to plan the exit of the individual from a high risk treatment program.

The method may further include the step of uploading at least one measured result from a diagnostic instrument to a computer. The measured result may be used to calculate at least one of an individual metric relating to a selected parameter or disease factor and the health status index score. The measured result may be further stored in a database for subsequent processing including a trend analysis.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flow chart representation of the methodology utilized to assess and quantify the health status of an individual according to an aspect of the present invention.

FIG. 2 is a tabular representation of the metric segmentation of the physiological parameters of blood pressure and LDL level into exemplary ranges.

FIG. 3 is a tabular representation of an importance scale that defines the relationship of selected physiological and/or psycho-social parameters.

FIG. 4 is an exemplary representation of an individual's health status index score calculation according to an aspect of the present invention.

FIG. 5 is another exemplary representation of an individual's health status index score calculation according to an aspect of the present invention.

FIG. 6 is a tabular representation of the comparison of the health status index score for a group of individuals as compared to a predetermined critical value that is established to assess the individual's current health status.

FIG. 7 is a graphical representation of a trend analysis over time of the health status of an individual.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are intended to be encompassed within the scope of the invention.

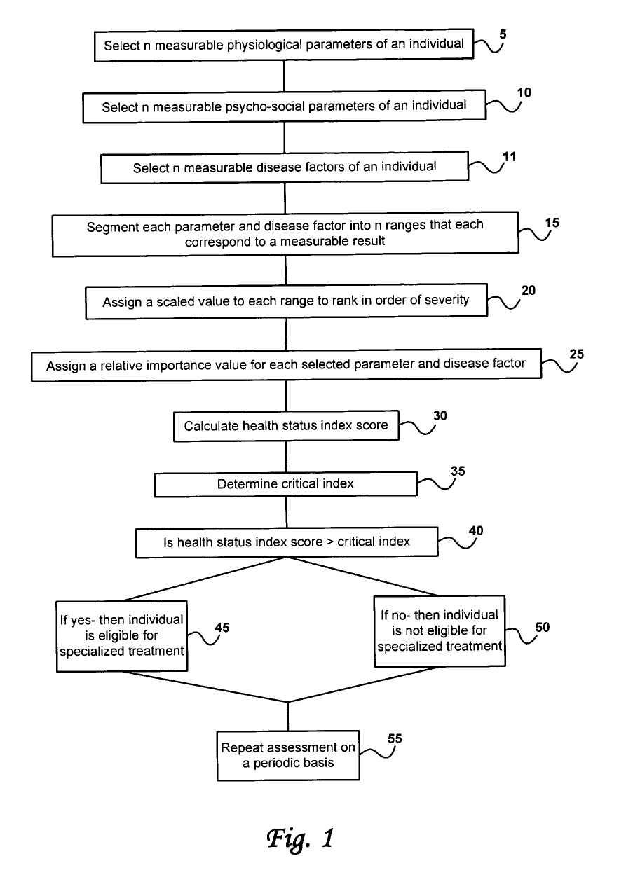

The methodology described herein utilizes at least one measured and scaled physiological and/or psycho-social parameter of an individual as part of an assessment, evaluation, and triage tool to quantitatively determine the current status of the health of that individual. The methodology may also include at least one disease factor which is also measured and scaled in a similar manner. Specifically, the measured and scaled data can be utilized to determine a baseline health status index score for the individual and to assess any changes in health status during the lifetime of the individual or at least during a particular course of treatment for the individual. The outcome can be utilized to predict the probability of a catastrophic event; to predict the individual's entry into a high risk specialized treatment program; to determine the individual's status as a high risk patient or to plan the exit of the individual from a high risk treatment program. Referring to FIGS. 1 through 7, the steps to perform a quantitative assessment of the current health status of an individual are shown.

Referring to FIG. 1, based on the currently known chronic conditions, relevant parameters and/or disease factors are selected for quantitative analysis. Accordingly, at step 5 at least one physiological parameter may be selected. A physiological parameter is defined as any bodily function or bodily excrement that can be assayed, cultured, measured or monitored. Thus, the physiological parameters that can be selected are unlimited. Physiological parameters that are appropriate for measurement may include, without limitation: body mass index (BMI), blood pressure (BP), heart rate (HR) (beats/min), low-density lipoprotein (LDL) level, temperature, hydration level, respiratory rate (breaths/min), body temperature (° C.), body weight (g), food consumption (g/100 g body-weight/day), water consumption (ml/100 g body-weight/day), in addition to blood chemistry components such as creatinine, sodium, potassium, BUN and HgbA1c.

The physiological parameters selected for analysis are not based solely on the currently diagnosed chronic conditions of the individual and the parameters that are affected thereby. Physiological parameters may also be selected based on other information known about the individual with regard to related co-morbidities for which the individual may or may not be symptomatic in addition to known genetic predispositions. Selection of such other parameters may be considered predictive with regard to the current status of the health of the individual, but the inclusion of these parameters is necessary to determine and/or anticipate the future healthcare requirements of the individual For example, an individual, referred to herein as Individual A, may be suffering from a number of known chronic conditions, such as w, x and y, of which a, b and c are the physiological parameters that can be measured and tested and which are indicative of the status of Individual A with respect to chronic conditions w, x and y. Thus, the healthcare provider may select physiological parameters a, b and c as parameters for evaluation in accordance with the methodology described herein.

Based on the known chronic conditions currently suffered by Individual A, the individual may also be at risk for another undiagnosed condition, z, of which d may be a measurable physiological parameter to assess the status of the condition. As previously discussed, z may be a known genetic predisposition or z may be a related or unrelated co-morbidity for which Individual A is currently asymptomatic. Even if Individual A is currently asymptomatic for condition z, the healthcare provider may select d, in addition to a, b, and c, as an additional physiological parameter that can be tested, measured and monitored. Although condition z correlates to a condition that may or may not be directly related to w, x and y, it is a condition that may be relevant to Individual A's current and future health status and healthcare treatment. Thus, the selected physiological parameters may include a, b and c, which are indicators of the currently diagnosed conditions of Individual A in addition to the physiological parameter d. The inclusion and monitoring of d may indicate, prevent or at least decrease the likelihood of Individual A suffering from a catastrophic event.

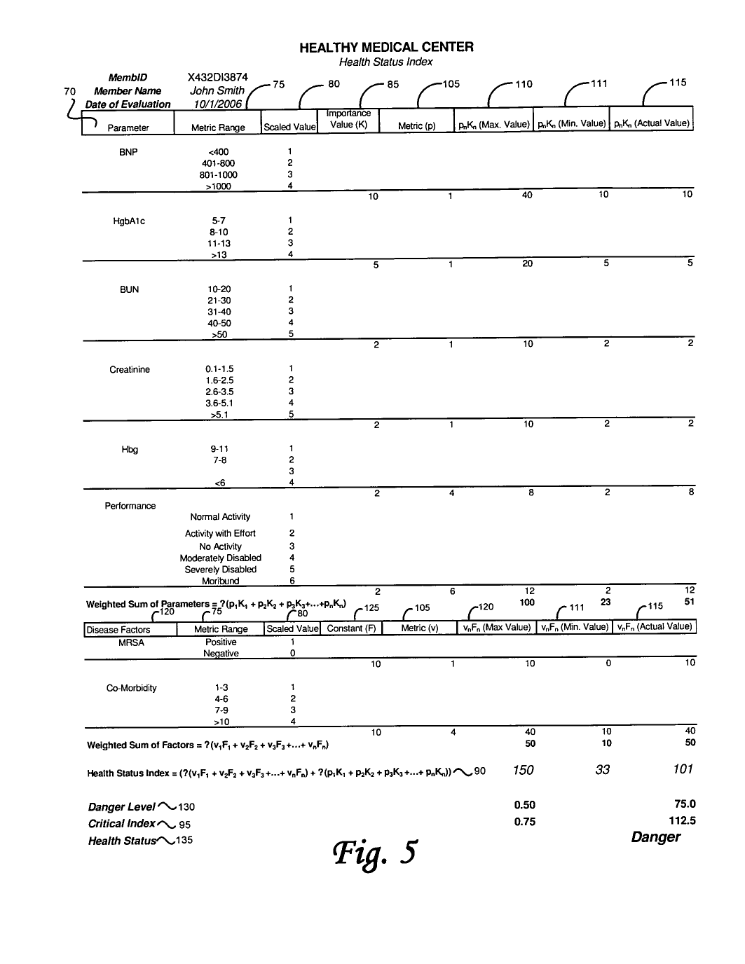

Similarly, at step 10, at least one psycho-social parameter may be selected. A psycho-social parameter is the behavioral response and mental attitude to any life event that may be affecting an individual. The corresponding measurement of a psycho-social parameter is usually subjective, and its assessment may be made by both the patient and/or the care-giver. Any number of psycho-social parameters may be selected for inclusion in a quantitative analysis in accordance with the methodology described herein. Examples of psycho-social parameters may include anxiety, fatigue, anger, hopelessness, depression, social support, sense of mastery, uncertainty, changed sleep patterns, stress, and weaning self-efficacy. Psycho-social parameters should be included in a quantitative assessment because an individual typically has a mental or other type of psychological adjustment to treatment that may or may not affect the effectiveness and the corresponding health status of that individual. In addition, psycho-social conditions often contribute on a varying level to certain physiological conditions. At step 11, at least one disease factor may be selected as further described herein with respect to FIG. 5.

At step 15, the selected physiological and/or psycho-social parameters are segmented into an n number of clearly defined ranges that each correspond to a range which should include a measurable result of an individual for that parameter. At step 20, a scaled value is assigned to each range for that parameter. The scaled value that is assigned to each defined range divides the parameter into a number of ranges that provide an indication of the status of the individual according to severity, as measured with respect to that parameter. The scaled values that are assigned to the defined ranges for each parameter may range from 1 to m, where 1 is the lowest or best value and m is the highest or worst value, as the range relates to the health of the individual.

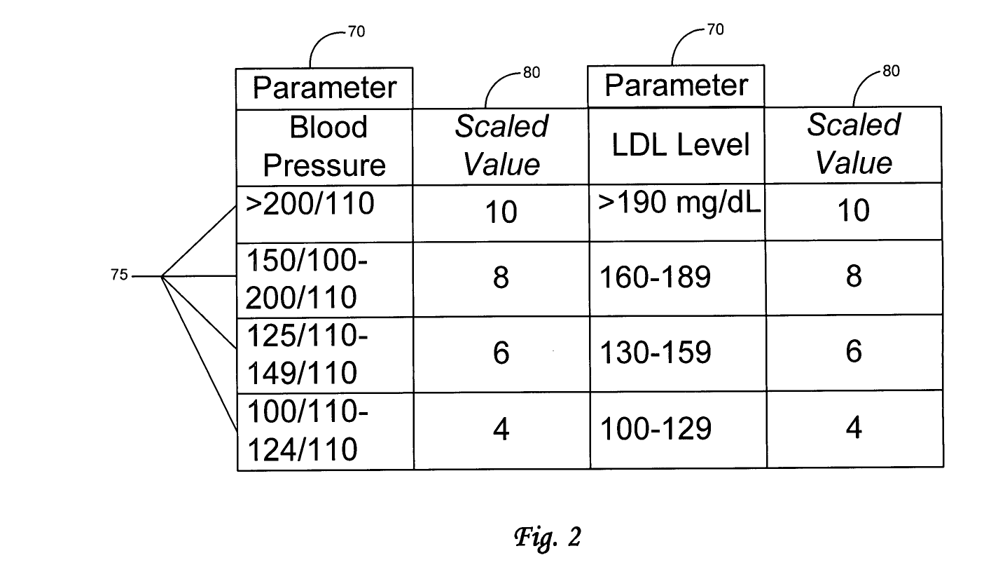

For example, FIG. 2 represents the segmentation of two exemplary parameters 70, the physiological parameters of blood pressure and low density lipoprotein level, into a clearly defined number of ranges 75 that each correspond to an scaled value 80. Generally, blood pressure is the pressure exerted by the blood on the walls of the blood vessels, and it is usually referred to as systemic arterial blood pressure. Blood pressure is normally expressed in millimeters of mercury and comprises the systolic pressure, which is the peak pressure in the arteries during the cardiac cycle, and the diastolic pressure which is the lowest pressure at the resting phase of the cardiac cycle. The typical value for a resting, healthy adult human is approximately 120/80, although large variations are possible depending on the particular individual. Specifically, blood pressure measurements are not static, but instead may vary naturally from one heartbeat to another, throughout the day or in response to factors such as stress, nutrition, drugs or disease. Typical blood pressure measurements among the elderly population may be even higher due to the reduced flexibility of the arteries, in connection with both normal aging and certain chronic conditions. This reduced flexibility is often associated with increased morbidity and mortality.

A blood pressure that exceeds a normal value is referred to as arterial hypertension and may be indicative of a more serious condition occurring elsewhere in the body. In fact, almost any elevated level of blood pressure puts mechanical stress on the arterial walls, which increases the workload of the heart and ultimately leads to the progression of unhealthy tissue growth, including but not limited to thickened, enlarged and/or weakened heart tissue. Blood pressure that is consistently elevated may be an indication of a possible future stroke, heart attack, heart failure or an arterial aneurysm. Elevated blood pressure may also be the source of certain conditions. Specifically, persistent hypertension has been found to be one of the leading causes of renal failure. It should be noted that blood pressure that is too low may also be indicative of other conditions occurring within the body. Chronic low blood pressure is also referred to as hypotension and can be a sign of severe disease that requires urgent medical attention. For example, decreased blood flow and associated blood pressure may lead to a perfusion of the brain which causes lightheadedness, dizziness and weakness. Thus, depending on the individual patient's particular health history, the value assigned to each segmented range of blood pressure may be assigned in a manner such that decreasing segmented ranges may be assigned correspondingly higher values.

In FIG. 2, the physiological parameter 70 of blood pressure is segmented into four clearly defined ranges 75 and corresponding scaled values 80 which include: 100/110 through 124/110 which is assigned a scaled value 80 of four (4); 125/110 through 149/110 which is assigned a scaled value 80 of six (6); 150/100 through 200/110 which is assigned a scaled value 80 of eight (8) and greater than 200/110 which is assigned a scaled value 80 of ten (10).

FIG. 2 also represents the segmentation of the physiological parameter 70 relating to the measurement of low-density lipoprotein (LDL) level. LDL level refers to a class of lipoprotein, in particular the lipoprotein that carries fatty acid molecules in the blood and around the body for use by the cells. The LDL level is commonly known as bad cholesterol because of the link between elevated levels of LDL and cardiovascular disease. LDL transports cholesterol and triglycerides from the liver and small intestines to the cells and tissues that are taking up cholesterol and triglycerides. Elevated LDL levels are often associated with atherosclerosis, myocardial infarctions, strokes, peripheral vascular disease and even death. Elevated LDL levels may also be hereditary, which is a genetic condition that is referred to as familial hypercholesterolemia. Thus, it can be appreciated that even if an individual patient is not currently suffering from an elevated LDL level, once a genetic predisposition is established, a healthcare provider may select this physiological parameter 70 to be incorporated into the quantitative assessment. Accordingly, the LDL levels are segmented into clearly defined ranges 75 corresponding to: 100 mg/dL through 129 mg/dL which is a near optimal level having a corresponding scaled value of four (4); 130 mg/dL through 159 mg/dL which is a borderline high level corresponding to a scaled value of six (6); 160 mg/dL through 189 mg/dL which is a high level and corresponds to a scaled value of eight (8) and greater than 190 mg/dL which corresponds to a very high level having the highest increased risk of heart disease and a corresponding scaled value of ten (10).

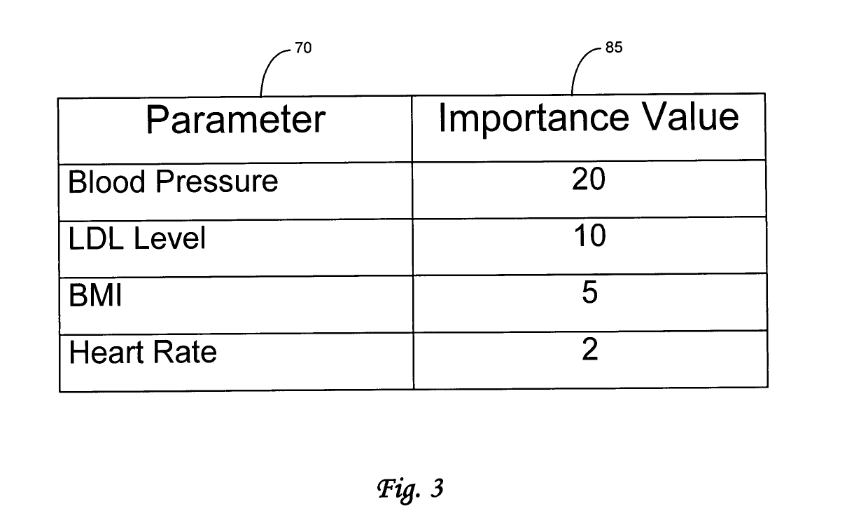

Referring to FIGS. 1 and 3, each parameter 70 is assigned an importance value 85 at step 25 based on the relative importance of each parameter 70 to each of the other parameters 70 for that individual. FIG. 3 represents an exemplary importance scale corresponding to the four selected parameters 70, namely, blood pressure, LDL level, body mass index and heart rate, which may be assessed to determine the current health status of an individual. The healthcare provider must determine the importance and relationship of each parameter 70 to the other parameters 70 and assign a corresponding importance value 85. The importance value 85 assigned to each parameter 70 should be weighted accordingly and should demonstrate a relationship not only to the health status of the individual but also between each of the selected parameters 70 and other disease factors that are further described herein. The importance value of each physiological and psycho-social parameter is analyzed to establish the relationship of one parameter 70 to another as being as twice as important, three times as important, and so forth.

Although the importance value 85 demonstrates rating the selected parameters 70 on a proportionate scale from one through twenty, it can be appreciated that the healthcare provider may select any numerical range of importance values 85 on which to rate the relationship of the parameters 70. In FIG. 3, blood pressure has been assigned an importance value 85 of twenty (20); LDL level has been assigned an importance value 85 of ten (10); BMI has been assigned an importance value 85 of five (5) and heart rate has been assigned an importance value 85 of two (2).

At step 30, a Health Status Index Score 90 is calculated for the individual patient according to the equation: HSI=(Σ(v₁F₁+v₂F₂+v₃F₃+ . . . +vₙFₙ)+Σ(p₁K₁+p₂K₂+p₃K₃+ . . . +pₙKₙ)) where v is the scaled value corresponding to the measured result for each disease factor from which a person currently suffers; F is the disease factor constant; p is the individual's score corresponding to the scaled value for each physiological or psycho-social parameter as determined by the individual's measured value for that parameter and K is the relative importance value assigned to each selected physiological and psycho-social parameter. As further described herein, there is no established value for F, as a disease factor constant, and K, as the relative importance value. Moreover, it is understood that any number of contributing factors may affect the health status of the individual and these factors may be reflected in the calculation of the health status index score, even if not specifically included. For example, advanced age is a contributing factor to the health status of an individual and it is proportional to increasing incidence and severity of disease conditions. The value provided for at least one disease factor constant and/or importance value may reflect the relationship of the individual's advanced age to his or her current health status, even if age is not included in the calculation of the health status index score.

It should be further understood by one skilled in the art that the health status index is a characterization of benchmark health factors to determine the health status of the individual. Depending on the number of selected parameters and disease factors, the health status index may be greater or lesser as warranted by the values that are established for a particular individual or group of individuals. Further, the particular selected parameters and/or disease factors in addition to the particular number of selected parameters and/or disease factors may be selected to create a particular type of health status index that is relative to a specific individual or subpopulation of individuals.

Although the disease factor constant and the importance value for each selected parameter and/or disease factors may not have an established value, it can further be appreciated by one skilled in the art that a regression analysis may be used to model relationships between the parameters and disease factors, determine the magnitude of the relationships and make predictions based on the relationships. Thus, the disease factor constant and importance value may be established for future calculations of the health status index score for individuals or population subsets based on previously collected data.

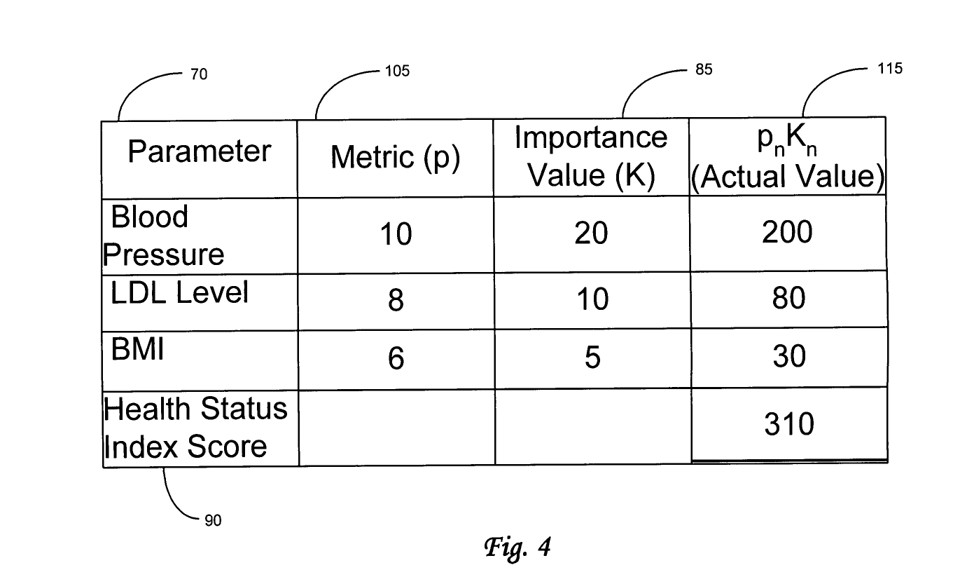

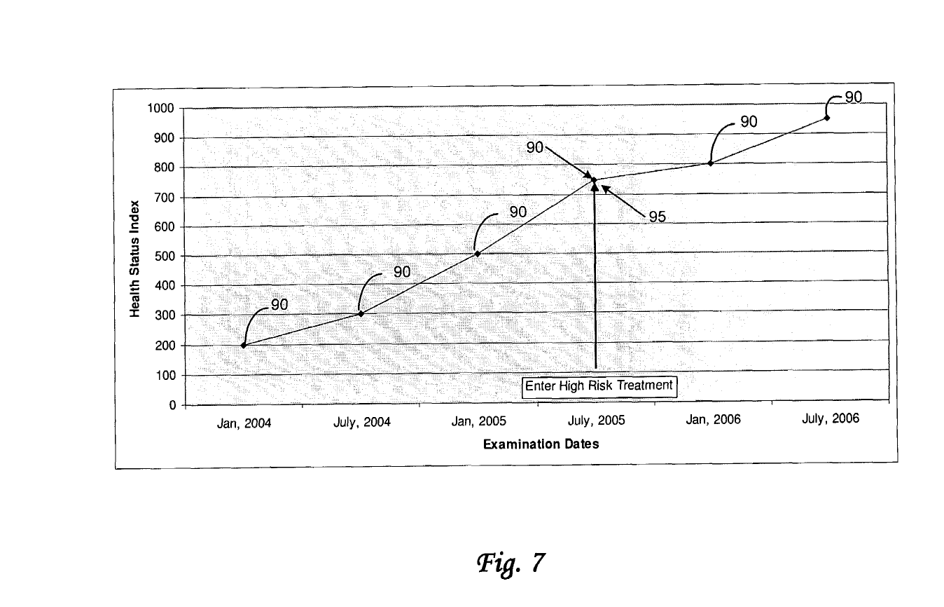

The calculation of the health status index score has an unlimited utility in determining the health status of the individual. The health status index score may be used to assess the current health status of the individual, as described in FIGS. 4, 5 and 6 or the health status index score may be used to predict or anticipate possible disease states of the individual as further described herein with respect to FIG. 7. To that end, it is contemplated that the calculation of the health status index score of the individual may be incorporated into any number of approaches used to assess an individual, including the teachings of U.S. patent application Ser. No. 11/514,585, filed Aug. 31, 2006 entitled Systems and Methods for Developing a Comprehensive Patient Profile, which is incorporated by reference herein in its entirety.

FIG. 4 represents one exemplary calculation of a health status index score which in its simplest form includes three parameters 70 for an individual that have been selected for evaluation, including blood pressure, LDL level and BMI. The actual value 115 of pₙKₙ, which represents an intermediate product, is determined for each parameter 70 by multiplying the individual metric 105 that corresponds to the appropriate scaled value, by the importance value 85 for that parameter 70. Referring to FIG. 2 and 4, the individual has a measured blood pressure greater than 200/110, a measurement that corresponds to an individual metric 105 of ten (10). The importance value 85 of blood pressure among the other measured parameters 70 is twenty (20). The individual metric 105 of ten (10) is multiplied by the importance value 85 of twenty (20) which equals two-hundred (200). The individual has a measured LDL level that falls within the range of 160-189 mg/dL which corresponds to an individual metric 105 of eight (8). LDL has an importance value 85 with respect to the other measured parameters 70 of ten (10). The individual metric 105 of eight (8) is multiplied by the importance value 85 of ten (10) which equals eighty (80). Finally, the individual patient has a measured BMI which corresponds to a score 105 of six (6). The importance value 85 of BMI with respect to the other parameters 70 for this individual is five (5). Accordingly, the individual metric 105 of six (6) is multiplied by the importance value 85 of five (5) which equals thirty (30). The actual value 115 of pₙKₙ for each selected parameter 70 is summed (Σp₁K₁+ . . . +pₙKₙ). The exemplary calculation of FIG. 4 does not contain any additional disease factors, as further described herein. Thus, in the calculation of HSI=(Σ(v₁F₁+v₂F₂+v₃F₃+ . . . +vₙFₙ) +Σ(p₁K₁+p₂K₂+p₃K₃+ . . . +pₙKₙ)) the value of Σ(v₁F₁+v₂F₂+v₃F₃+ . . . +vₙFₙ) is equal to zero (0) and the value of Σ(p₁K₁+p₂K₂+p₃K₃+ . . . +pₙKₙ) is equal to three hundred ten (310) which equals a health status index score 90 of three hundred ten (310).

FIG. 5 is a representation of a more complex exemplary calculation of a health status index 90 for an individual. The parameters 70 selected for analysis include the physiological parameters of BNP, HgbA1c, BUN, creatinine and Hgb, and, in addition, the psycho-social parameter of performance has also been selected. Similar to the previously analysis, each of the physiological parameters has been segmented into a number of ranges 75 that each correspond to a measurable result that is indicative of the health status of the individual relative to that parameter. For example, B-type Natriuretic Peptide, BNP, refers to a substance that is secreted from the ventricles or lower chambers of the heart in response to changes in pressure that occur when heart failure develops and worsens. The BNP level in the blood increases when heart failure symptoms worsen, and decrease when the heart failure condition is stable. The BNP level in an individual with heart failure is typically higher than in a person with a normal heart function.

In FIG. 5, BNP is segmented into four defined ranges 75 that each correspond to a range which should include a measurable result of an individual for that parameter and a scaled value 80 has been assigned to each range 75. A BNP level below 400 corresponds to zero to minimal heart failure and a scaled value 80 of one (1). A BNP level from 401 through 800 indicates that mild to moderate heart failure is present, a condition that represents a scaled value 80 of two (2). A BNP level ranging from 801 through 1000 indicates that moderate to severe heart failure is present and the corresponding scaled value 80 is three (3). Finally, a BNP level greater than 1000 indicates that the individual is in severe heart failure which corresponds to a scaled value 80 of four (4). Similarly, the psycho-social parameter of performance has been selected and segmented into a number of ranges that correspond to the daily activity of the individual. For example, if an individual is exhibiting normal activity, the scaled value 80 of one (1) and so forth. The least active individual is classified as moribund which corresponds to a scaled value 80 of six (6).

Each parameter 70 is further assigned an importance value 85 demonstrating the relation of the parameter 70 to each of the other parameters 70 and disease factors 120. Next, an individual metric 105 for each parameter is determined based on the appropriate scaled value 80 corresponding to the measured result of the parameter 70 for that individual. The maximum value 110 of pₙKₙ represents the maximum score 105 the individual can obtain based on the maximum scaled value 80 corresponding to a measured result multiplied by the importance value 85 of the parameter 70. Similarly, the minimum value 111 of pₙKₙ represents the minimum score 105 the individual can obtain based on the minimum scaled value 80 corresponding to a measured result multiplied by the importance value of the parameter. Finally, the actual value 115 of pₙ Kₙ represents the actual score 105 of the individual based on the scaled value 80 corresponding to the actual measured result multiplied by the importance value 85 of that parameter 70. The actual value of pₙKₙ 115 for each selected parameter 70 is summed (Σp₁K₁+ . . . +pₙ Kₙ). In the calculation of HSI=(Σ(v₁F₁+v₂F₂+v₃F₃+ . . . +vₙFₙ)+Σ(p₁K₁+p₂K₂+p₃K₃+ . . . +pₙKₙ)) in FIG. 5, the value of Σ(p₁K₁+p₂K₂+p₃K₃+ . . . +pₙKₙ) is equal to fifty-one (51).

As shown in FIG. 5, in addition to the selected parameters 70, the health status index may also include additional disease factors 120, including without limitation, at least one of a co-morbidity, MRSA, VRE, Valley Fever, HIV status, tuberculosis, C-Diff, the number of hospitalizations, insulin dependence, incontinence of bowel or bladder, steroid dependence, oxygen dependence, cirrhosis/hepatitis with abnormal LFTS, level of forced lung expiration, lung vital capacity and age. Each disease factor 120 is segmented into n number of ranges 75 in a manner similar to the other parameters 70, as appropriate and each range 75 is further assigned a scaled value 80. A constant 125, which is a value similar to the importance value 85 that is assigned to each of the other selected parameters, is assigned to each disease factor 120,. Specifically the constant 125 assigned to each disease factor 120 represents the weight of the disease factor 120 of the individual with respect to the other parameters 70, the other disease factors 120 and the current health status of the individual. There is no established value for the constant 125 and the value may be set by the healthcare provider.

For example, the disease factor 120 associated with co-morbidity represents the number of co-morbidities from which an individual is known to suffer. The co-morbidity state for an individual may be segmented into a number of ranges 75, depending on the number of chronic conditions from which an individual may suffer. In FIG. 5, co-morbidity is segmented into four ranges; each range 75 is assigned a scaled value 80 and a constant 125 is assigned to the disease factor 120. The individual metric 105 for the disease factor 120 of co-morbidity is four which represents that the individual has greater than ten co-morbidities and the constant 125 has been set at a value of ten. Depending on the number of co-morbidities from which an individual suffer, the constant 125 may be set at a higher or lower value. The maximum value 110 of vₙFₙ for the disease factor 120 of co-morbidity is represented in FIG. 5 as forty and the minimum value 111 of vₙFₙ of for the disease factor 120 of co-morbidity is represented as ten. The individual metric 105 for co-morbidity represented in FIG. 5 is multiplied by the constant 125 associated with co-morbidity to determine the actual value of 115 of vₙFₙ which is forty (40).

Another example of a disease factor 120 is the MRSA factor, which stands for methicillin-resistant Staphylococcus aureus. MRSA is a type of bacterium commonly found on the skin and/or in the noses of healthy people. Although it is usually harmless at these sites, it may occasionally get into the body through breaks in the skin such as abrasions, cuts, wounds, surgical incisions or indwelling catheters and cause infections. These infections may be mild, such as in the form of pimples or boils, or the infection may be more serious, such as an infection of the bloodstream, bones or joints. The health status index score 90 may include the disease factor 120 for MRSA for the individual, which should only yield one of two ranges 75, positive or negative and two corresponding scaled values 80. With regard to the disease factor 120 for MRSA, the individual is assessed an individual metric 105 based on the measured result of the MRSA test. The individual metric 105 is multiplied by the constant 125 for the disease factor 120 of MRSA to determine the value of vₙFₙ. The maximum value 110 of vₙFₙ for the disease factor 120 for MRSA is represented in FIG. 5 as ten (10) and the minimum value 111 of vₙFₙ 111 for the disease factor 120 for MRSA is zero (0). The individual metric 105 for the disease factor 120 for MRSA is one indicating that the individual is positive for the disease factor 120 of MRSA which represents an actual value vₙFₙ 115 of ten (10).

The actual value 115 of vₙFₙ for each selected disease factor 120 is summed (Σv₁F₁+ . . . +vₙFₙ) and is equal to fifty (50). Thus, in the calculation of HSI=(Σ(v₁F₁+v₂F₂+v₃F₃+ . . . +vₙFₙ) +Σ(p₁K₁+p₂K₂+p₃K₃+ . . . +pₙKₙ the value of Σ(v₁F₁+v₂F₂+v₃F₃+ . . . +vₙFₙ) which is equal to fifty (50) and the value of Σ(p₁K₁+p₂K₂+p₃K₃+ . . . +pₙKₙ) which is equal to fifty one (51) are summed together to calculate the health status index score 90 which is equal to one hundred one (101).

Referring to FIGS. 1, 5 and 6, at step 35, the healthcare provider may establish a critical index level 95, which is the minimum health index status score 90 that should cause an individual to be authorized for high risk or other specialized treatment. There is no set established value for this value, which may be set by the healthcare provider based on the identified parameters 70, including physiological and/or psycho-social, of the individual, the other disease factors 120 and the perceived health status of the individual. The healthcare provider may utilize the same critical index level 95 for multiple individuals having the same identified parameters 70 or the healthcare provider may adjust the critical index level 95 accordingly based on measurements that may be normal for that individual. Referring to FIG. 5, a danger level 130 may additionally be established which is a minimum score at which a healthcare provider should be alerted to potential developing conditions of the individual. Similar to the critical index value 95, there is no established value for the danger level 130. It should be noted that these values may established in view of the age of the individual. For example, an older individual that is known to be prone to disease may have a lower danger level 130 and critical index value 95 to ensure that conditions may be proactively managed well before the occurrence of a catastrophic event or before an advanced disease stage develops.

At step 40, the individual's health status index score 90 is compared with the critical index level 95 to determine the individual's health status. If the health status index 90 is greater than the critical index level 95, then the member is eligible for specialized healthcare services, such as high risk treatment at step 45. If the health status index score 90 is less than the critical index level 95, the member is not eligible for such specialized healthcare services at step 50.

FIG. 5, represents a utilization of both a danger level 130 and a critical index level 95. The danger level for the individual represented in FIG. 5 has been set at fifty percent of the maximum attainable health status index score 90. This corresponds to a value of seventy-five relative to the parameters 70 and disease factors 120 identified in FIG. 5. The critical index level 95 has been set at seventy-five percent of the maximum attainable health status index score 90 which corresponds to a value of 112.5 relative to the parameters 70 and disease factors 120 identified in FIG. 5. Again, neither the danger level 130 nor the critical index level 95 is an established value and each may depend on the individual that is assessed in addition to any evaluation by the healthcare provider. The value set for the danger level 130 and critical index level 95 may further differ between individuals that are being assessed for a current health status. The health status index score 90 of the individual represented in FIG. 5 is equal to 101 which places the individual in a danger category, as identified by the individual's health status indicator 135. The health status indicator 135 represents a non-numerical status label associated with the individual's health status index score 90. Appropriate treatment should be instituted depending on the parameters 70 and disease factors 120 that have been measured and analyzed.

It can be appreciated by one skilled in the art that any one of the individual metric 105 relating to the measured and scaled parameters and disease factors, in addition to the health status index score 90, the danger level 130, the critical index level 95 and the health status indicator 135 may be automatically calculated. Specifically, in one embodiment, various testing and measuring instruments and devices associated with the diagnostic testing of an individual may be networked so that the diagnostic test result data for each measured parameter is transmitted from the appropriate instrument or device to a computer by a data communication medium. The data communication medium may be a physical connection, such a serial connection or the data communication medium may be a short-range wireless transmission, such as infrared or RF transmission. Once the test result data is transmitted to the computer, the data may be uploaded into a program for the further calculation according to the methodology described herein. The data may be stored in a database for subsequent processing such as a trend analysis, as described with respect to FIG. 7.

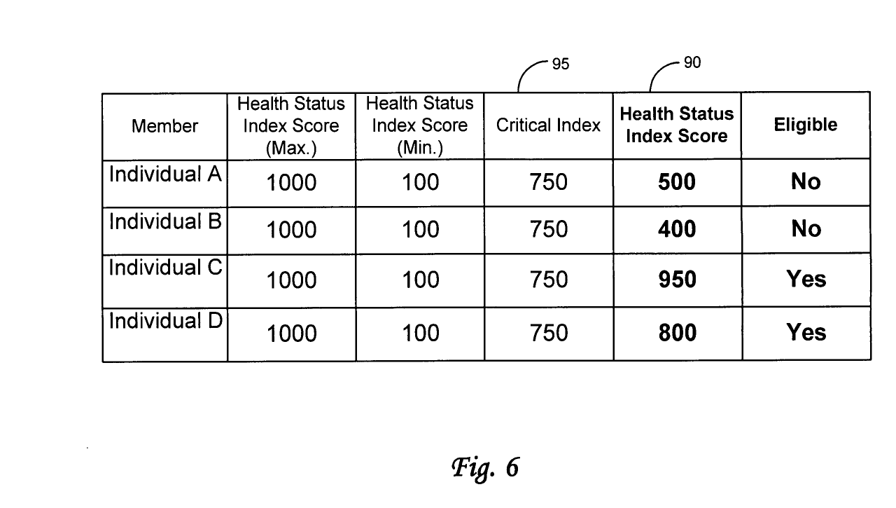

It can also be appreciated by one skilled in the art that the each of the representations of the calculation of the health status index score, as shown in FIGS. 5 and 6, are not the only representations of such calculation. The calculation of the health status index score and determination of the relative health status may further be presented to the healthcare provider in a variety of formats, including electronic or print, and may be displayed alone or in connection with a combination of numbers, symbols and/or other characters. The presentation of the health status index score may be abbreviated to include only certain features of the calculation or the presentation may be more detailed depending on the preference of the healthcare provider and the intended utilization of the information.

FIG. 6 represents four individuals that are assessed for entrance into high risk treatment. Each individual is assessed based on a number of selected parameters and disease factors. The lowest and highest possible health status index scores 90 are a function of the number of parameters 70, either physiological and/or psycho-social and disease factors 120 that are utilized in the calculation of the health status index score 90. For example, in FIG. 6, the lowest possible health status index score 90 is 100 and the highest possible health status index score 90 is 1000. The critical index level 95 has been established at 750 and is the point at which the individual should enter some form of high risk or other specialized treatment program. Individual A has a health status index score 90 of 500, which is less than the required critical index level 95 of 750. Similarly, Individual B has a health status index score 90 of 400 which is less than the required critical index level 95 of 750. Accordingly, the health status of either of Individuals A or B has not reached the appropriate level to cause the individuals to be placed in a high risk treatment program. Individual C has a health status index score 90 of 950 which well exceeds the critical index level 95 of 750. Thus, Individual C is a candidate for immediate entry into a high risk treatment program. Similarly, Individual D has a health status index score 90 of 800, which exceeds the critical index level 95 of 750. Individual D also requires immediate entry into a high risk treatment program.

Referring to FIG. 1, the evaluation of the physiological metrics should be done on a periodic basis at step 55, regardless of whether the individual patient never received any type of high risk treatment; is currently receiving high risk treatment or no longer receives high risk treatment; or at a danger level. For example, if an individual has an early stage chronic condition that has not placed that individual at risk for a catastrophic event, the corresponding physiological parameters, in addition to other physiological and/or psycho-social parameters, which correspond to the evaluation of any condition, whether related or unrelated, should be evaluated on an interval basis, such as during the individual's regularly scheduled physical. The individual may only visit the healthcare provider on a yearly basis, or the individual may be evaluated every six months, as shown in FIG. 7. However, each time that the individual visits his or her healthcare provider, the relevant physiological parameters should be measured and evaluated in accordance with the methodology described herein.

FIG. 6 represents a trend analysis 100 of an individual's health status index score 90. As shown in FIG. 6, the individual has visited his or her healthcare provider six times between January 2004 and July 2006 at a frequency of every six months. In January 2004, the health status index score 90 is calculated at 200. In July 2004, the health status index score 90 is calculated at 300. In January 2005, the health status index score 90 is calculated at 500. In July 2005, the health status index score is calculated at 750. The trend analysis 100 represents that physiological and/or psycho-social parameters have been identified at a point in time and are currently monitored on a regular basis corresponding to the individual's visit to his healthcare provider. It can be appreciated that the parameters, as initially measured, were low at the January 2004 visit and continued to increase, as measured at each subsequent visit. It is reasonable to assume that the individual is suffering from at least one chronic condition that is causing the values to increase, and the healthcare provider is likely prescribing some form of treatment for the chronic condition. However, the treatment is not effective for some reason that cannot be easily ascertained from the graph. A variety of reasons may cause the treatment to be ineffective, including the failure of the individual to comply with the healthcare provider's directives or the failure of the patient to respond to the prescribed treatment.

In July 2005, the health status index score 90 of the individual is equal to the critical index level 95, which warrants placement of the individual into a high risk treatment program to prevent a catastrophic event. This health status index score 90 may be caused by at least one of the parameter metric values reaching an elevated level. In January 2006, the individual patient's health status index score 90 indicates that the condition is not under control, as the score has increased by 50. Finally, in January 2006, the individual's health status index score 90 has reached a level of 950. The continued evaluation provides an indication to the healthcare providers that the individual must remain in high risk treatment. The increase in value of the health status index score 90 may also indicate that the likelihood of a catastrophic event is almost inevitable.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1. A method for the quantitative assessment and triage of the health status of an individual comprising:
selecting at least two measurable parameters of an individual;
segmenting each parameter into a plurality of ranges that include a measured result for each selected parameter;
assigning a scaled value to each range for each selected parameter to order the ranges according to severity;
assigning an importance value for each selected parameter that establishes a proportionate relationship between the selected parameters;
calculating a health status index score by multiplying an individual metric based on the scaled value which corresponds to the measured result of an individual by the importance value for each selected parameter to obtain an intermediate product and summing each of the intermediate products;
determining a critical index that corresponds to a minimum health status index score that causes an individual to be authorized for specialized treatment.

2. The method for the quantitative assessment and triage of the health status of an individual of claim 1, wherein at least one measurable parameter is a physiological parameter and at least one measurable parameter is a psycho-social parameter.

3. The method for the quantitative assessment and triage of the health status of an individual of claim 2, wherein the physiological parameters include at least one of body mass index, blood pressure, heart rate, low-density lipoprotein level, temperature, hydration level, respiratory rate, body temperature, body weight, food consumption, water consumption, creatinine, sodium, potassium, BUN and HgbA1c.

4. The method for the quantitative assessment and triage of the health status of an individual of claim 2, wherein the psycho-social parameters include at least one of anxiety, fatigue, anger, hopelessness, depression, social support, sense of mastery, uncertainty, changed sleep patterns, stress, weaning self efficacy and activity level.

5. The method for the quantitative assessment and triage of the health status of an individual of claim 1, further comprising at least one selected disease factor.

6. The method for the quantitative assessment and triage of the health status of an individual of claim 5, wherein the disease factor is at least one of a MRSA factor, a co-morbidity factor or a tuberculosis factor.

7. The method for the quantitative assessment and triage of the health status of an individual of claim 5, further comprising the steps of
(a) segmenting each disease factor into a plurality of ranges that include a measured result for each disease factor;
(b) assigning a scaled value to each range for each disease factor to order the ranges according to severity;
(c) assigning a constant to each disease factor that establishes a proportionate relationship between each disease factor and each selected parameter and
(d) calculating a health status index score by multiplying an individual metric based on the scaled value which corresponds to the measured result of an individual by the importance value for each disease factor to obtain an intermediate product and summing each of the intermediate products.
wherein the health status index score includes the sum of the intermediate products for each of the selected disease factors and the selected parameters.

8. The method for the quantitative assessment and triage of the health status of an individual of claim 1, further comprising a danger index corresponding to a minimum health status index score that provides an indication of at least one developing chronic condition.

9. The method for the quantitative assessment and triage of the health status of an individual of claim 1, further comprising a danger index that causes an individual to be put on observation for specialized treatment.

10. The method for the quantitative assessment and triage of the health status of an individual of claim 1, wherein the health status index score is associated with a health status indicator.

11. The method for the quantitative assessment and triage of the health status of an individual of claim 1, further comprising the step of comparing the health status index score to the critical index to monitor the health status of an individual.

12. The method for the quantitative assessment and triage of the health status of an individual of claim 8, further comprising the step of comparing the health status index score to the danger index to monitor the health status of an individual.

13. The method for the quantitative assessment and triage of the health status of an individual of claim 11, wherein the health status index score is compared to the critical index to determine at least one of: the probability of a catastrophic event; the entry of an individual into a specialized treatment program; an individual's continuing status in a specialized treatment program or the exit of the individual from a specialized treatment program.

14. The method for the quantitative assessment and triage of the health status of an individual of claim 12, wherein the health status index score is compared to the danger index to determine at least one of: the probability of a catastrophic event; the entry of an individual into a specialized Treatment program; an individual's continuing status in a specialized treatment program or the exit of the individual from a specialized treatment program.

15. The method for the quantitative assessment and triage of the health status of an individual of claim 1, further comprising the step of trending the calculated health status index score to monitor the health status of an individual.

16. The method for the quantitative assessment and triage of the health status of an individual of claim 1, further comprising the step of uploading at least one measured result from a diagnostic instrument to a computer.

17. The method for the quantitative assessment and triage of the health status of an individual of claim 1, further comprising the step of presenting the health status in an electronic format.

18. The method for the quantitative assessment and triage of the health status of an individual of claim 1, wherein at least one measured result is stored electronically.

19. The method for the quantitative assessment and triage of the health status of an individual of claim 1, further comprising the step of performing a regression analysis to determine a value for the disease factor constant and the importance value.

20. The method for the quantitative assessment and triage of the health status of an individual of claim 15, wherein at least one health status index score is calculated while the individual is considered healthy.

21. The method for the quantitative assessment and triage of the health status of an individual of claim 15, wherein the health status index score is calculated about every six months.

22. The method for the quantitative assessment and triage of the health status of an individual of claim 1, wherein at least one measurable parameter is a subjective measurement.

23. The method for the quantitative assessment and triage of the health status of an individual of claim 22, wherein the subjective measurement is made by the individual.

24. The method for the quantitative assessment and triage of the health status of an individual of claim 22, wherein the subjective measurement is made by a caregiver to the individual.

25. The method for the quantitative assessment and triage of the health status of an individual of claim 2, wherein the physiological parameters include at least one of a measurable physiological parameter indicative of the status of the individual with respect to an undiagnosed condition.
